(19) United States
(12) Patent Application Publication
(10) Pub. No.: US 2013/0045777 A1
(43) Pub. Date: Feb. 21, 2013

(54) WIRELESS COMMUNICATIONS MODULE, USER EQUIPMENT, AND WIRELESS COMMUNICATION METHOD

(71) Applicant: Huawei Device Co., Ltd., Shenzhen (CN)

(72) Inventors: Meiwen YANG, Shenzhen (CN); Keqiang GAO, Shenzhen (CN)

(73) Assignee: Huawei Device Co., Ltd., Shenzhen (CN)

(21) Appl. No.: 13/658,811

(22) Filed: Oct. 23, 2012

Related U.S. Application Data
(63) Continuation of application No. PCT/CN2011/073216, filed on Apr. 23, 2011.

(30) Foreign Application Priority Data
Apr. 23, 2010 (CN) 201010154212.7

(51) Int. Cl. H04W 88/02

(52) U.S. Cl. 455/558

(57) ABSTRACT

A wireless communications module, a User Equipment (UE), and a wireless communication method. One embodiment of the present invention comprises a wireless communications module, including: a baseband processor; a Secure Digital (SD) card interface coupled to the baseband processor; a Subscriber Identity Module unit (SIM unit), coupled to the baseband processor, configured to store parameter information including subscriber identity information; and a Radio Frequency (RF) processing unit coupled to the baseband processor, wherein the baseband processor is configured to process a baseband signal based on the parameter information. With at least some embodiments of the present invention, the space occupied by the wireless communications module reduced, UEs capable of Internet access are diversified, and the user experience is improved.

### CROSS REFERENCE TO RELATED APPLICATIONS

This application is a continuation of International Application No. PCT/CN2011/073216, filed on Apr. 23, 2011, which claims priority to Chinese Patent Application No. 201010154212.7, filed on Apr. 23, 2010 and entitled “Wireless Internet Module, User Equipment, Secure Digital Memory Card and Wireless Communication Method”, both of which are hereby incorporated by reference in their entireties.

### FIELD OF THE INVENTION

The present invention relates to wireless communication technologies, and in particular, to a wireless communications module, a User Equipment (UE), and a wireless communication method.

### BACKGROUND OF THE INVENTION

With development of wireless data services, wireless Internet modules prevail due to considerable uplink and downlink rates, simplicity, and convenience. A wireless Internet module is generally connected to a Personal Computer (PC) through an independent interface. Because an interface of a PC is generally located on the mainboard, the wireless Internet module needs to be set on the mainboard of the PC. An independent interface may be a Universal Serial Bus (USB) stick interface, an express card interface, a mini PCI-E interface, or a Personal Computer Memory Card International Association (PCMIA) interface.

### SUMMARY OF THE INVENTION

Embodiments of the present invention provide a wireless communicationsmodule, a User Equipment (UE), and a wireless communication method.

One embodiment of the present invention provides a wireless communications module, including: a baseband processor; a Secure Digital Memory Card (SD card) interface coupled to the baseband processor; a Subscriber Identity Module unit (SIM unit), coupled to the baseband processor, configured to store parameter information including subscriber identity information; and a Radio Frequency (RF) processing unit coupled to the baseband processor; wherein the baseband processor is configured to process a baseband signal based on the parameter information.

Another embodiment of the present invention provides a User Equipment (UE), including: a Secure Digital (SD) card interface, wherein the processor and SD card interface are configured to receive and process data based on a baseband signal received by a wireless communications module; wherein the wireless communications module includes a baseband processor; a Secure Digital (SD) card interface, coupled to the baseband processor; a Subscriber Identity Module unit (SIM unit), coupled to the baseband processor, configured to store parameter information including subscriber identity information; and a Radio Frequency (RF) processing unit coupled to the baseband processor, wherein the baseband processor is configured to process a baseband signal based on the parameter information.

Yet another embodiment of the present invention provides a wireless communication method performed by a wireless communications module, including: receiving uplink multiplex (MUX) data information from a User Equipment (UE) through a Secure Digital Memory Card (SD card) interface; identifying the uplink MUX data information; sending the uplink MUX data information through a transmission control command interface if the uplink MUX data information comprises a transmission control command; and sending the uplink MUX data information through a transmission network packet interface if the uplink MUX data information includes a transmission network packet.

Another embodiment of the present invention provides a wireless communications module, including: a Secure Digital card interface and a processor coupled to the SD card interface and configured to: receive uplink Multiplex (MUX) data information from a User Equipment (UE) through the SD card interface; identify the uplink MUX data information; send the uplink MUX data information through a transmission control command interface if the uplink MUX data information comprises a transmission control command; and send the uplink MUX data information through a transmission network packet interface if the uplink

MUX data information includes a transmission network packet.

A further embodiment of the present invention provides a User Equipment (UE), including: a Secure Digital (SD) card interface and a processor coupled to the secure digital memory card slotand configured to: encapsulate data information received via the SD card interface into downlink multiplex (MUX) data information; and send the downlink MUX data information to a processing unit in the UE.

The wireless communications module of the present invention uses the SD card interface to implement communication between the UE and the module. Therefore, all UEs that support the SD card interface can perform wireless network communication, and the functions of wireless Internet access and data storage can be implemented by using the SD card in wireless mode. The wireless communications module occupies only the space required by the SD card, which enables developers to design smaller UEs and more diversified UEs capable of Internet access.

### BRIEF DESCRIPTION OF THE DRAWINGS

FIG. 1 shows a structure of a wireless Internet module 100 according to an embodiment of the present invention;

FIG. 2 shows a wireless Internet processing submodule 102 in a wireless Internet module 100 according to an embodiment of the present invention;

FIG. 3 shows a structure of a wireless Internet module 100 according to an embodiment of the present invention;

FIG. 4 shows a structure of UE according to an embodiment of the present invention;

FIG. 5 is a flowchart of a wireless communication method according to an embodiment of the present invention;

FIG. 6 is a flowchart of another wireless communication method according to an embodiment of the present invention;

FIG. 7 shows a structure of a wireless Internet module according to an embodiment of the present invention;

FIG. 8 shows a structure of a UE according to an embodiment of the present invention;

FIG. 9 shows a signal flow between a wireless Internet module and a corresponding UE in an embodiment of the present invention;

FIG. 10 shows a structure of a packet transmitted on a Serial Peripheral Interface (SPI) or a Secure Digital Input and Output (SDIO) bus in an embodiment of the present invention; and

FIG. 11 shows an SD card according to an embodiment of the present invention.

### DETAILED DESCRIPTION OF THE EMBODIMENTS

The following describes a wireless Internet module, a UE, and a wireless communication method provided herein with reference to the accompanying drawings.

It should be noted that the term “SD card” as used in this application is intended to cover all sizes and interfaces of the SD card supported by the Secure Digital standard.

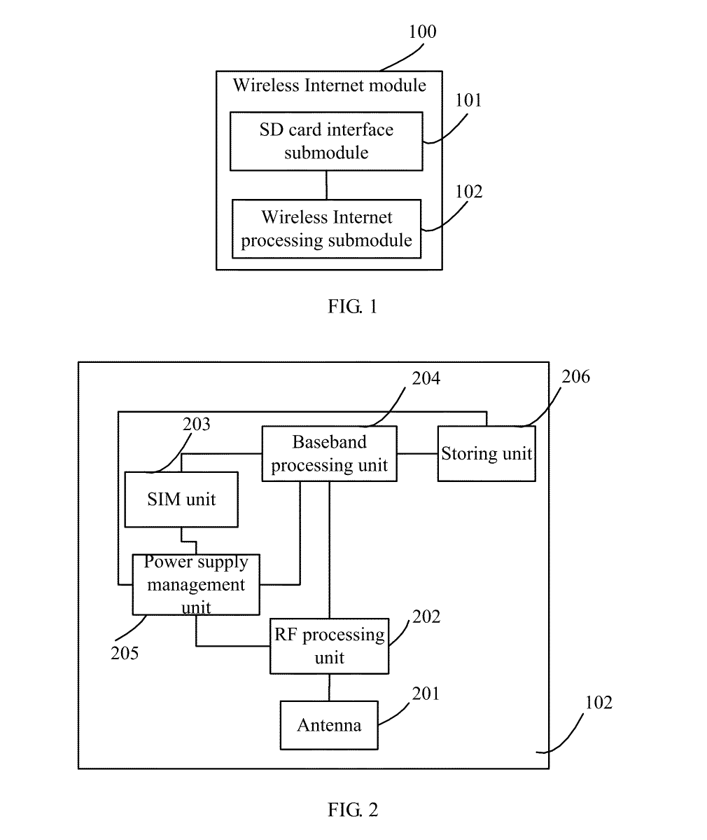

FIG. 1 shows a structure of a wireless Internet module 100 according to an embodiment of the present invention. The module includes an SD card interface submodule 101 and a wireless Internet processing submodule 102, where the wireless Internet processing submodule 102 exchanges information with the UE through the SD card interface submodule 101.

The wireless Internet module 100 can be inserted into the UE through an SD card slot or a Micro Secure Digital Memory Card (MicroSD) slot to establish a wireless connection. With the UE, the user can access the Internet through a wireless network, for example, send a photo through the wireless network.

The SD card interface submodule includes an SDIO interface submodule or an SPI submodule. The SDIO interface submodule corresponds to an SD bus communication mode; and the SPI submodule corresponds to an SPI bus communication mode. The SD card interface submodule is an SD card interface. The SDIO interface submodule is an SDIO interface and the SPI submodule is an SPI serial interface.

The appearance of the wireless Internet module 100 is the same as the appearance of the SD card. For example, the size of the wireless Internet module 100 may be the size of the SD card (24 mm×32 mm×2.1 mm). Both the SDIO interface submodule and the SPI submodule may be understood as interfaces of the SD card. The information exchanged by the wireless Internet processing submodule 102 and the UE through the SD card interface submodule 101 may include wireless data traffic information and a driver. The wireless data traffic information may include: a transmission network packet and a transmission control command obtained after a radio signal received through the antenna are processed by a Radio Frequency (RF) processing unit and a baseband processing unit. The driver includes a MUX driver.

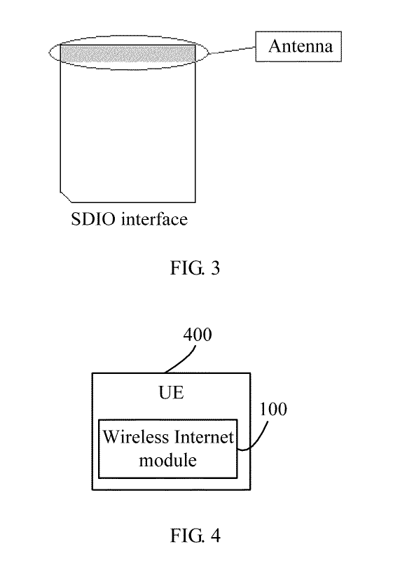

FIG. 2 shows a wireless Internet processing submodule 102 in a wireless Internet module according to an embodiment of the present invention. The wireless Internet processing submodule 102 includes an antenna 201, an RF processing unit 202, a Subscriber Identity Module (SIM) unit 203, and a baseband processing unit 204.

The antenna 201 is configured to transmit received radio signal to the RF processing unit 202, or convert the signal transmitted by the RF processing unit 202 into a electromagnetic wave and send the electromagnetic wave.

It should be noted that the antenna 201 may be set in the mainboard of the wireless Internet module. As shown in FIG. 3, the SD card interface submodule 101 is located on a side of the wireless Internet module and the antenna 201 is located on the other side of the wireless Internet module, namely, the antenna 201 and the SD card interface are located on two different sides of the wireless Internet module. Alternatively, the antenna may be an external antenna which is connected to the RF processing unit through a mainboard contact of the wireless Internet module.

It should be noted that an area may be reserved around the antenna, and that no component is allowed to be set in this area.

The RF processing unit 202 is configured to perform frequency selection, amplification, and down-conversion on the radio signal received by the antenna 201, convert the radio signal into a intermediate frequency signal or a baseband signal, and send the signal to the baseband processing unit; or the RF processing unit 202 is configured to perform up-conversion and appropriate amplification on the baseband signal or intermediate frequency signal sent by the baseband processing unit 204, and send the signal through the antenna 201.

The SIM unit 203 is configured to store user parameter information. The user parameter information may include information about the digital mobile phone user and an encryption key, through which the network authenticates the identity of the user and encrypts the voice information generated in the conversation of the user.

It should be noted that the SIM unit may be a chip packed with SIM dies.

The baseband processing unit 204 is configured to process received intermediate frequency signal or baseband signal according to the parameter information obtained by the SIM unit 203, and requirements of the MUX driver and the wireless communication; or, receive the MUX data information, in which the data information is sent by the UE through the SD card interface submodule 101; identify the MUX data information; and send the data information through a transmission control command interface if the data information includes a transmission control command, or, send the data information through a transmission network packet interface if the data information includes a transmission network packet.

It should be noted that the wireless Internet processing submodule 102 may further include a power supply management unit 205 and a storing unit 206.

The power supply management unit 205 is configured to convert supply voltage of the UE into voltage required by the baseband processing unit 204, storing unit 206, RF processing unit 202, and SIM unit 203 to supply power to such units.

The storing unit 206 is configured to store the transmission network packet obtained by the baseband processing unit 204 and an application required for running the wireless Internet module.

The storing unit 206 may be configured to store a running program of the wireless Internet module; or, the storing unit 206 may serve two purposes: (1) serve as storage space for storing an external file, like an SD card; and (2) store the running program of the wireless Internet module.

As shown in FIG. 4, a UE 400 provided in an embodiment of the present invention includes the wireless Internet module 100 described above. For more details, see the description about the wireless Internet module 100 above.

The wireless Internet module may be set in an SD card slot of the UE, or in a MicroSD card slot.

It should be noted that: Because the wireless Internet module employs an SDIO interface or SPI interface of the SD card, and the appearance of the wireless Internet module is the same as the appearance of the SD card or MicroSD card, the wireless Internet module can be integrated in any portable apparatus that has an SD card interface, for example, a digital camera, a Personal Digital Assistant (PDA), and a multimedia player. In this way, the wireless Internet is applied in a wider field.

It should be noted that the wireless Internet module may be based on, but without being limited to 3rd-generation (3G) standards such as Wideband Code Division Multiple Access (WCDMA), Time Division-Synchronous Code Division Multiple Access (TD-SCDMA), Code Division Multiple Access (CDMA), and Worldwide Interoperability for Microwave Access (WiMAX); and 4G standards.

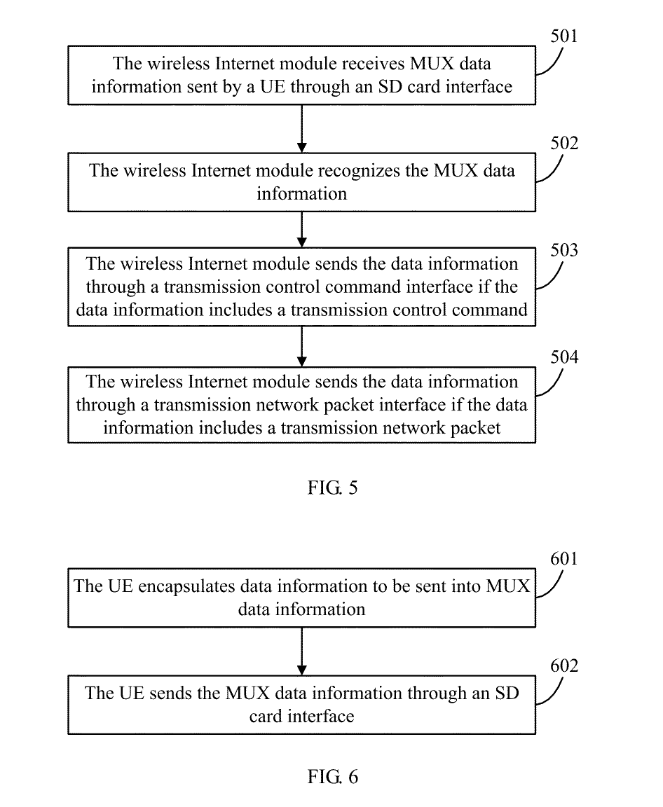

FIG. 5 shows a wireless communication method according to an embodiment of the present invention. The method includes the following steps:

501. The wireless Internet module receives MUX data information, in which the data information is sent by a UE through an SD card interface.

502. The wireless Internet module identifies the MUX data information.

503. The wireless Internet module sends the data information through a transmission control command interface if the data information includes a transmission control command.

504. The wireless Internet module sends the data information through a transmission network packet interface if the data information includes a transmission network packet.

It should be noted that the method further includes:

The wireless Internet module receives a wireless digital signal, which is a intermediate frequency signal or a baseband signal sent by the RF processing unit.

The wireless Internet module encapsulates the wireless digital signal into MUX data information.

The wireless Internet module sends the MUX data information to the UE. Specifically, the baseband processing unit 204 in the wireless Internet module lets the RF processing unit 202 process the MUX data information. The processed data information is sent to the antenna 201, and is finally sent out from the antenna 201.

FIG. 6 shows another wireless communication method according to an embodiment of the present invention. The method includes the following steps:

601. The UE encapsulates data information to be sent into MUX data information.

602. The UE sends the MUX data information through an SD card interface.

It should be noted that the method further includes:

The UE receives the MUX data information, in which the data information is sent by a wireless Internet submodule through the SD card interface.

The UE identifies the MUX data information.

The UE sends the data information through a transmission control command interface if the data information includes a transmission control command.

The UE sends the data information through a transmission network packet interface if the data information includes a transmission network packet.

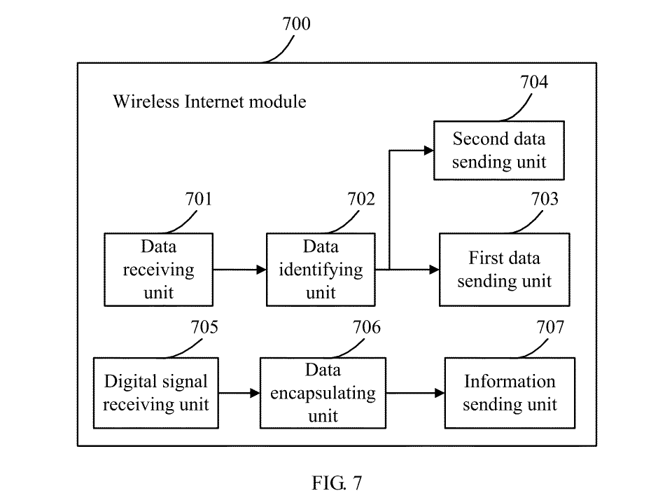

FIG. 7 shows a structure of a wireless Internet module 700 according to an embodiment of the present invention. The module includes:

a data receiving unit 701, configured to receive MUX data information, in which the data information is sent by a UE through an SD card interface;

a data identifying unit 702, configured to identify the MUX data information;

a first data sending unit 703, configured to send the data information through a transmission control command interface if the data information includes a transmission control command; and

a second data sending unit 704, configured to send the data information through a transmission network packet interface if the data information includes a transmission network packet.

It should be noted that the wireless Internet module 700 further includes:

a digital signal receiving unit 705, configured to receive a wireless digital signal;

a data encapsulating unit 706, configured to encapsulate the wireless digital signal into MUX data information; and

an information sending unit 707, configured to send the MUX data information to the UE.

It should be noted that the data receiving unit 701, data identifying unit 702, first data sending unit 703, second data sending unit 704, digital signal receiving unit 705, data encapsulating unit 706, and information sending unit 707 can be set in the baseband processing unit.

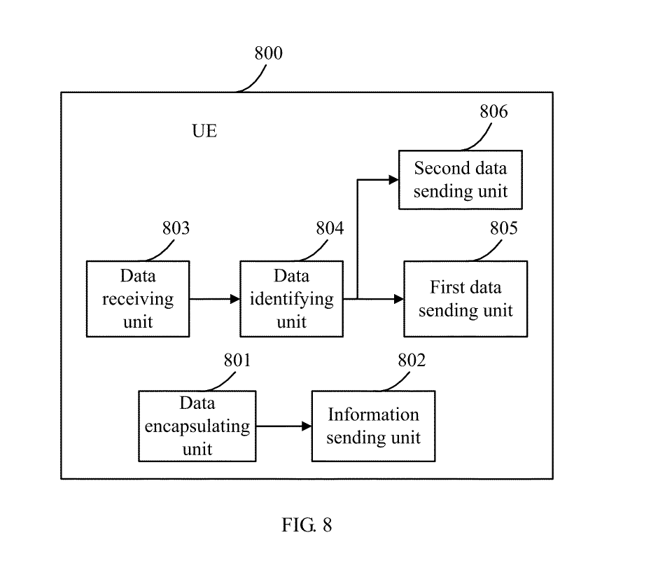

FIG. 8 shows a UE 800 according to an embodiment of the present invention. The UE includes:

a data encapsulating unit 801, configured to encapsulate data information to be sent into MUX data information; and

an information sending unit 802, configured to send the MUX data information through an SD card interface.

It should be noted that the UE further includes:

a data receiving unit 803, configured to receive the MUX data information, in which the data information is sent by a wireless Internet submodule through the SD card interface;

a data identifying unit 804, configured to identify the MUX data information;

a first data sending unit 805, configured to send the data information through a transmission control command interface if the data information includes a transmission control command; and

a second data sending unit 806, configured to send the data information through a transmission network packet interface if the data information includes a transmission network packet.

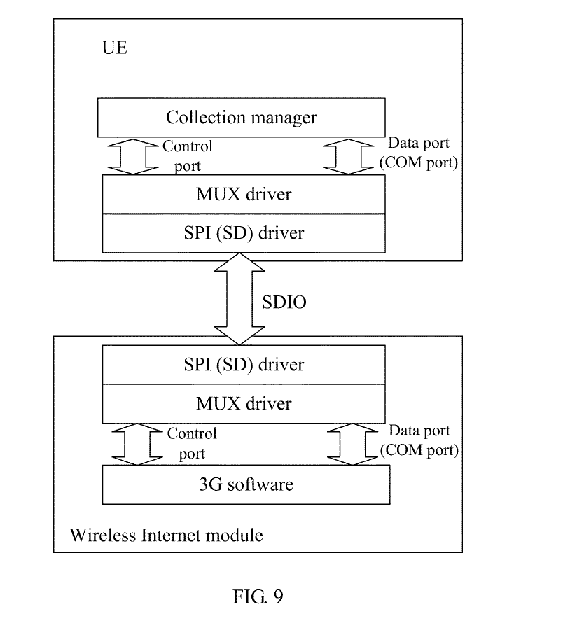

Based on the embodiments above, assuming the SPI bus (or SD bus) communication mode is configured for the wireless Internet module for 3G communication. As shown in FIG. 9, a MUX driver is configured for the UE and the wireless Internet module. The storing unit in the wireless Internet module may be configured to store an application, the SPI (or SD) driver, MUX driver, and 3G software. In this way, the 3G software in the wireless Internet module can exchange information with the UE through the transmission control command interface and transmission network packet interface that are provided by the MUX driver. The information exchange includes two processes. The first process is: The UE sends data information to the wireless Internet module; and the second process is: The wireless Internet module sends data information to the UE.

Process 1:

Before the UE sends data information to the wireless Internet module, the MUX driver encapsulates data information to be sent into MUX data information. The encapsulated MUX data information is sent to the wireless Internet module through an SPI (or SD) bus. The data information includes at least one of: a transmission control command and a transmission network packet.

When the wireless Internet module receives the MUX data information, the wireless Internet module obtains the MUX data information from the SPI (or SD) bus, and then the MUX driver identifies the MUX data information. The transmission control command in the MUX data information is sent to the corresponding processing unit through a transmission control command interface, and the transmission network packet in the MUX data information is sent to the corresponding processing unit through the transmission network packet interface.

Process 2:

When the wireless Internet module sends data information to the UE, the wireless Internet module sends the data information received by the antenna to the RF processing unit, and the RF processing unit performs frequency selection, amplification, and down-conversion on the received data information, converts the data information into a intermediate frequency signal or a baseband signal, and sends the signal to the baseband processing unit. Afterward, the baseband processing unit encapsulates the intermediate frequency signal or baseband signal into MUX data information, and sends the MUX data information to the UE through an SPI (or SD) bus.

When the UE receives the MUX data information, the UE retrieves the MUX data information from the SPI (or SD) bus, and then the MUX driver identifies the MUX data information. The MUX driver sends the identified data to the transmission control command interface and the transmission network packet interface according to an information type. Finally, the data information is sent to a dashboard of the UE for processing. Two ports are provided by the MUX driver (the two ports are two COM ports in the Windows system, namely, a transmission control command interface and a transmission network packet interface). The transmission control command interface is used to transmit a control command to the MUX driver, and the transmission network packet interface is used to transmit a network packet to the MUX driver.

It should be noted that after receiving the data information from the transmission control command interface and the transmission network packet interface, the MUX driver sends the data information through an SPI (or SD) bus, where the network packet takes priority.

The UE may be a PC which does not include a wireless Internet module, a laptop computer, a digital camera, a digital video recorder, or a data card. The embodiments of the present invention are not limited to the types of the UE.

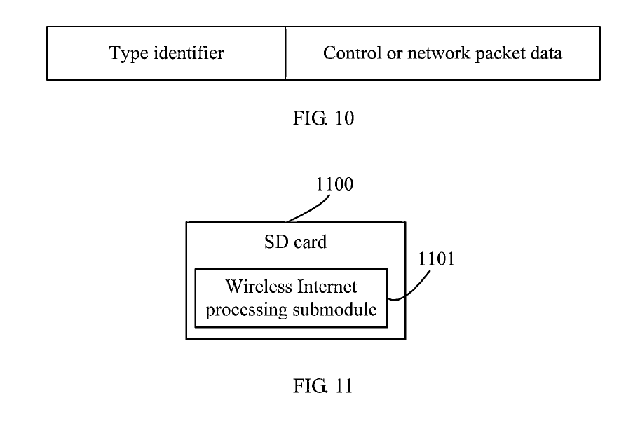

It should be noted that: The packets transmitted on the SPI (or SD) bus may be defined in the way shown in FIG. 10, for example, the identifier of the type of the control command is defined as 0, and the identifier of the type of the network packet is defined as 1.

When the MUX driver in the wireless Internet module receives data from the transmission control command interface (command port), the data is encapsulated into a packet whose type identifier is 0, and the data is sent to the UE through the SPI (or SD) bus. When the MUX driver in the wireless Internet module receives data from the transmission network packet interface (data port), the data is encapsulated into a packet whose type identifier is 1, and the data is sent to the UE through the SPI (or SD) port.

As shown in FIG. 11, an SD card 1100 provided in an embodiment of the present invention includes a wireless Internet processing submodule 1101, which exchanges information with a UE through an SD card interface. The SD card 1100 can be inserted into the UE through an SD card slot or a MicroSD card slot to establish a wireless connection. With the UE, the user can access the Internet through a wireless network, for example, send a photo through the wireless network.

The SD card may include: an SDIO interface and an SPI serial interface.

For more details of the wireless Internet submodule 1101, see the description about FIG. 2 above.

A wireless Internet module, a UE, and a wireless communication method are provided herein. The wireless Internet processing submodule in the wireless Internet module exchanges information with the UE through the SD card interface submodule. The appearance of the wireless Internet module is the same as the appearance of the SD card. The wireless

Internet module uses the SD card interface submodule of the SD card to implement communication between the UE and the module. Therefore, all UEs that support the SD card interface submodule of the SD card can perform wireless network communication, and the functions of wireless Internet access and data storage can be implemented by using the existing SD card space in wireless mode.

A UE provided in an embodiment of the present invention includes a wireless Internet module mentioned above. The wireless Internet module occupies only the space required by the SD card, which enables developers to design smaller UEs and more diversified UEs capable of Internet access, and improves the user experience.

Persons of ordinary skill in the art should understand that all or part of the steps of the method specified in any embodiment above may be implemented by a program instructing relevant hardware. The program may be stored in computer-readable storage media such as a Read Only Memory/Random Access Memory (ROM/RAM), a magnetic disk, or a Compact Disk-Read Only Memory (CD-ROM). When the program runs, the program executes the steps of the method specified in any embodiment above.

The above descriptions are merely exemplary embodiments of the present invention, but not intended to limit the scope of the present invention. Any modifications, variations or replacements shall fall within the scope of the present invention. Therefore, the scope of the present invention is subject to the appended claims.

What is claimed is:

1. A wireless communications module, comprising:
a baseband processor;
a Secure Digital (SD) card interface coupled to the baseband processor;
a Subscriber Identity Module unit (SIM unit), coupled to the baseband processor, configured to store parameter information including subscriber identity information; and
a Radio Frequency (RF) processing unit coupled to the baseband processor,
wherein the baseband processor is configured to process a baseband signal based on the parameter information.

2. The wireless communications module according to claim 1, wherein the configuration of the wireless communications module is the same as the configuration of an SD card.

3. The wireless communications module according to claim 1, wherein:
the baseband processor is configured to process the baseband signal according to the parameter information obtained by the SIM unit and to requirements of a multiplex (MUX) driver and a wireless protocol; and
wherein the baseband processor is further configured to:
receive multiplex (MUX) data information sent by a User Equipment (UE) through the SD card interface;
identify the MUX data information;
send the data information through a transmission control command interface if the data information comprises a transmission control command, or send the data information through a transmission network packet interface if the data information comprises a transmission network packet.

4. The wireless communications module according to claim 3, further comprising:
a storing unit configured to store the transmission network packet obtained by the baseband processor and an application required for running the wireless communications module.

5. The wireless communications module according to claim 4, further comprising:
a power supply management unit configured to convert a supply voltage of the UE into a voltage required by the baseband processor, storing unit, RF processing unit, and SIM unit to supply power to such units.

6. The wireless communications module according to claim 1, wherein the wireless communications module further comprises an antenna configured to couple to the RF processing unit.

7. The wireless communications module according to claim 6, wherein:
the antenna is set in a mainboard of the wireless communications module, or the antenna is connected to the RF processing unit through a mainboard contact of the wireless communications module.

8. The wireless communications module according to claim 1, wherein:
the SIM unit comprises a plurality of SIM dies.

9. The wireless communications module according to claim 1, wherein:
the SD card interface comprises a Secure Digital Input and Output (SDIO) interface or a Serial Peripheral Interface (SPI).

10. A User Equipment (UE), comprising:
a processor; and
a Secure Digital (SD) card interface, wherein the processor and SD card interface are configured to receive and process data based on a baseband signal received by a wireless communications module, wherein the wireless communications module comprises:
a baseband processor;
a Secure Digital (SD) card interface coupled to the baseband processor;
a Subscriber Identity Module unit (SIM unit), coupled to the baseband processor, configured to store parameter information including subscriber identity information; and
a Radio Frequency (RF) processing unit coupled to the baseband processor,
wherein the baseband processor is configured to process a baseband signal based on the parameter information.

11. The User Equipment (UE) according to claim 10, wherein the wireless communications module further comprises an antenna configured to couple to the RF processing unit.

12. A wireless communication method performed by a wireless communications module, comprising:
receiving uplink multiplex (MUX) data information from a User Equipment (UE) through a Secure Digital (SD) card interface;
identifying the uplink MUX data information;
sending the uplink MUX data information through a transmission control command interface if the uplink MUX data information comprises a transmission control command; and
sending the uplink MUX data information through a transmission network packet interface if the uplink MUX data information comprises a transmission network packet.

13. The wireless communication method according to claim 12, further comprising:
receiving a wireless digital signal;
encapsulating the wireless digital signal into downlink MUX data information; and
sending the downlink MUX data information to the UE through the Secure Digital Memory Card interface.

14. A wireless communications module, comprising:
a Secure Digital (SD) card interface; and
a processor coupled to the SD card interface and configured to:
receive uplink multiplex (MUX) data information from a User Equipment (UE) through the SD card interface;
identify the uplink MUX data information;
send the uplink MUX data information through a transmission control command interface if the uplink MUX data information comprises a transmission control command; and
send the uplink MUX data information through a transmission network packet interface if the uplink MUX data information comprises a transmission network packet.

15. The wireless communications module according to claim 14, wherein the processor is further configured to:
receive a wireless digital signal;
encapsulate the wireless digital signal into downlink MUX data information; and
send the downlink MUX data information to the UE.

16. A User Equipment (UE), comprising:
a Secure Digital (SD) cardinterface; and
a processor coupled to the secure digital memory card slot and configured to:
encapsulate data information received via the SD card interface into downlink multiplex (MUX) data information; and
send the downlink MUX data information to a processing unit in the UE.

17. The UE according to claim 16, wherein the processor is further configured to:
receive uplink MUX data information sent by a wireless Internet submodule through a SD card interface;
identify the uplink MUX data information;
send the uplink MUX data information through a transmission control command interface if the uplink MUX data information comprises a transmission control command; and
send the uplink MUX data information through a transmission network packet interface if the uplink MUX data information comprises a transmission network packet.
